(19) United States
(12) Patent Application Publication
(10) Pub. No.: US 2003/0095019 A1
(43) Pub. Date: May 22, 2003

(54) Tabless surface mount coaxial dielectric resonator

(76) Inventors: Allen M. Hobbs, San Diego, CA (US); Dennis R. Clark, Delmar, CA (US)

Correspondence Address: David E. Heisey, Esq., LUCE, FORWARD, HAMILTON & SCRIPPS LLP, 600 West Broadway, Suite 2600, San Diego, CA, 92101, US

(21) Appl. No.: 09/999,068

(22) Filed: Nov. 19, 2001

(51) Int. Cl. H01P 7/04

(52) U.S. Cl. 333/222

(57) ABSTRACT

A resonator including a resonator body having a longitudinally extending through hole, an electrically conductive coating formed on the inner and outer surfaces of the resonator and an electrical gap formed by cutting a groove around the circumference of the body. The groove divides the resonator body into a short section and a long section, wherein the short section is used as a conductive pad for attachment to a circuit board.

### FIELD OF THE INVENTION

The present invention is directed to resonators, and more particularly to tabless coaxial dielectric resonators.

### BACKGROUND OF THE INVENTION

Coaxial resonators having high performance ceramic dielectric materials are commonly used as compact frequency standards, filter elements, and distributed inductive or capacitive circuit elements. Most coaxial resonators are square, rectangular or circular, and have a circular hole extending through the length of the resonator body. These resonators are typically either quarter wave resonators having one end fully metallized (i.e., shorted) and the other end open, or as half wave resonators having both ends open. For surface mounting, metallic tabs are usually employed to solder coaxial resonators to a circuit board.

Referring to FIGS. 1(a) and 1(b), a conventional quarter wave ceramic coaxial resonator 10 has a square resonator body 20 and a metal connecting tab 30. This tab 30 is attached to a conductive coating 40 within the diameter of a through hole 50 using solder 60. The conductive coating 40 also envelops the entire perimeter of the square resonator body 20 except for the tabbed end face 65, which has a square shape. FIGS. 2(a) and 2(b) depict a conventional quarter wave ceramic coaxial resonator 10 having a circular resonator body 70. Once more, the tab 30 is attached to the conductive coating 40 inside through hole 50 with solder 60, and the conductive coating 40 surrounds the entire perimeter of the circular resonator body 20 except for the tabbed end face 75, which has a circular shape.

Referring to FIGS. 3(a) and 3(b), the square coaxial resonator 10 of FIG. 1(a) is improperly mounted to a circuit board via metal connecting pad 80 of electrical circuit 80, 90. The metal tab 30 is adapted to make an electrical connection between the through hole 50 and metal connecting pad 80 of the electrical circuit 90. Typically, the metal tab 30 is attached to the connecting pad 80 using a soldering process.

The conventional tabbed coaxial resonator embodiments depicted in FIGS. 1-3 suffer from a number of drawbacks. As mentioned above, the metal tab 30 is connected to the resonator body 20 by soldering the tab 30 inside through hole 50. While the solder 60 is being heated for melting, there is a danger that the conductive coating 40 could leach or dissolve inside the through hole 50 causing an open failure or weak adhesion. Additionally, during the soldering of the tab 30 to the connecting pad 80, the solder 60 connecting the tab 30 to the resonator through hole 50 may reflow and causing the tab 30 could become loose.

Referring to FIGS. 3(a) and 3(b), a further problem concerning conventional tabbed coaxial resonators is the variation in tab 30 position with respect to the connecting pad 80. Due to ceramic shrinkage and metal coating thickness variations, the tab 30 could be too long. As depicted in FIG. 3(a), this raises the resonator body 20 off the circuit 80, 90 making soldering of the body 20 to the circuit 90 more difficult. As depicted in FIG. 3(b), ceramic shrinkage and coating thickness variation may also cause the tab 30 to be too short to connect to connecting pad 80.

In view of the foregoing problems with tabbed coaxial resonators, there is a substantial need for a coaxial resonator having an inexpensive substitute for a tab for making a proper electrical connection between resonator and circuit.

### SUMMARY OF THE INVENTION

One aspect of the present invention involves a resonator including a resonator body having a longitudinally extending through hole, an electrically conductive coating formed on the inner and outer surfaces of the resonator and an electrical gap formed by cutting a groove around the circumference of the body.

Another aspect of the present invention involves a resonator including a resonator body having a longitudinally extending through hole, an electrically conductive coating formed on the inner and outer surfaces of the resonator and an electrical gap, wherein the grove is formed by grinding, sawing or laser scribing.

A further aspect of the present invention involves a resonator including a resonator body having a longitudinally extending through hole, an electrically conductive coating formed on the inner and outer surfaces of the resonator and an electrical gap, wherein the groove is formed by masking an area around the circumference of the body before the conductive coating is applied and removing the mask after the conductive coating is applied, to form a non-conductive band.

An addition aspect of the present invention involves a resonator including a resonator body having a longitudinally extending through hole, an electrically conductive coating formed on the inner and outer surfaces of the resonator and an electrical gap, wherein the resonator has a square resonator body having six facets and the electrical gap is formed in four facets of the square resonator body.

Yet another aspect of the present invention involves a resonator including a resonator body having a longitudinally extending through hole, an electrically conductive coating formed on the inner and outer surfaces of the resonator and an electrical gap, which divides the resonator body into a short section and a long section, wherein the short section is used as a conductive pad for attachment to a circuit board.

A further aspect of the present invention involves a resonator including a resonator body having a longitudinally extending through hole, an electrically conductive coating formed on the inner and outer surfaces of the resonator and an electrical gap, wherein the conductive coating near the electrical gap is removed to increase the resonator frequency, and wherein the conductive coating on one end of the resonator body is removed to decrease the resonator frequency.

Another aspect of the present invention involves a method of making a resonator, including forming a resonator body, forming a longitudinally extending through hole in the body such that the body, coating the inner and outer surfaces with an electrically conductive coating and forming an electrical gap around the circumference of the body.

An additional aspect of the present invention involves a method of making a resonator, including forming a resonator body, forming a longitudinally extending through hole in the body such that the body, coating the inner and outer surfaces with an electrically conductive coating and forming an electrical gap around the circumference of the body by cutting, grinding, sawing or laser scribing a groove around the perimeter of the body.

Yet another aspect of the present invention involves a method of making a resonator, including forming a resonator body, forming a longitudinally extending through hole in the body such that the body, coating the inner and outer surfaces with an electrically conductive coating and forming an electrical gap around the circumference of the body by masking an area around the circumference of the body before the conductive coating is applied and removing the mask after the conductive coating is applied forming a non-conductive band.

Another aspect of the present invention involves a method of making a resonator, including forming a resonator body, forming a longitudinally extending through hole in the body such that the body, coating the inner and outer surfaces with an electrically conductive coating, dividing the resonator body into a short section and a long section with a non-conductive band and using the short section as a conductive pad for attachment to a circuit board.

A further aspect of the present invention involves a method of making a resonator, including forming a circular resonator body, forming a longitudinally extending through hole in the body such that the body, coating the inner and outer surfaces with an electrically conductive coating, dividing the resonator body into a short section and a long section and using the short section as a conductive pad for attachment to a circuit board.

An additional aspect of the present invention involves a method of making a resonator, including forming a circular resonator body, forming a longitudinally extending through hole in the body such that the body, coating the inner and outer surfaces with an electrically conductive coating, removing the conductive coating near the electrical gap to increase the resonator frequency and removing the conductive coating on one end of the resonator body to decrease the resonator frequency.

Further applicability of the present invention will become apparent from a review of the detailed description and accompanying drawings. It should be understood that the description and examples, while indicating preferred embodiments of the present invention, are not intended to limit the scope of the invention, and various changes and modifications within the spirit and scope of the invention will become apparent to those skilled in the art.

### BRIEF DESCRIPTION OF THE DRAWINGS

The present invention will become more fully understood from the detailed description given below, together with the accompanying drawings, which are given by way of illustration only, and are not to be construed as limiting the scope of the present invention. In the drawings:

FIG. 1(a) is a side view of a square surface mount ceramic coaxial resonator with a connecting tab protruding out one end of the resonator.

FIG. 1(b) is an end view of the square surface mount ceramic coaxial resonator of FIG. 1(a) showing the tab soldered to the inside diameter of the resonator.

FIG. 2(a) is a side view of a cylindrical surface mount ceramic coaxial resonator with a connecting tab protruding out one end of the resonator.

FIG. 2(b) is an end view of the cylindrical surface mount ceramic coaxial resonator of FIG. 2(a) showing the tab soldered to the inside diameter of the resonator.

FIG. 3(a) is a side view of the square surface mount ceramic coaxial resonator of FIG. 1(a) with a long tab.

FIG. 3(b) is a side view of a surface mount ceramic coaxial resonator of FIG. 1(a) with a short tab.

FIG. 4(a) is a perspective view of a tabless, square ceramic coaxial resonator having a circumferential groove according to one embodiment of the present invention.

FIG. 4(b) is a side view of the tabless, square ceramic coaxial resonator of FIG. 4(a).

FIG. 5(a) is a perspective view of a tabless, cylindrical ceramic coaxial resonator having a circumferential groove according to another embodiment of the present invention.

FIG. 5(b) is a side view of the tabless, cylindrical ceramic coaxial resonator of FIG. 5(a).

FIG. 6(a) is a perspective view of a tabless, square ceramic coaxial resonator having a non-conductive gap according to another embodiment of the present invention.

FIG. 6(b) is a side view of the tabless, square ceramic coaxial resonator of FIG. 6(a).

FIG. 7(a) is a perspective view of a tabless, cylindrical ceramic coaxial resonator having a non-conductive gap according to another embodiment of the present invention.

FIG. 7(b) is a side view of the tabless, cylindrical ceramic coaxial resonator of FIG. 7(a).

FIG. 8(a) is a side view of the tabless, square ceramic coaxial resonator of FIG. 4(a) mounted to a circuit board.

FIG. 8(b) is a side view of the tabless, cylindrical ceramic coaxial resonator of FIG. 7(a) mounted to a circuit board.

FIG. 9 is a side view of a tabless ceramic coaxial resonator with conductive coating removed near the groove and at one end of the resonator according to another embodiment of the present invention.

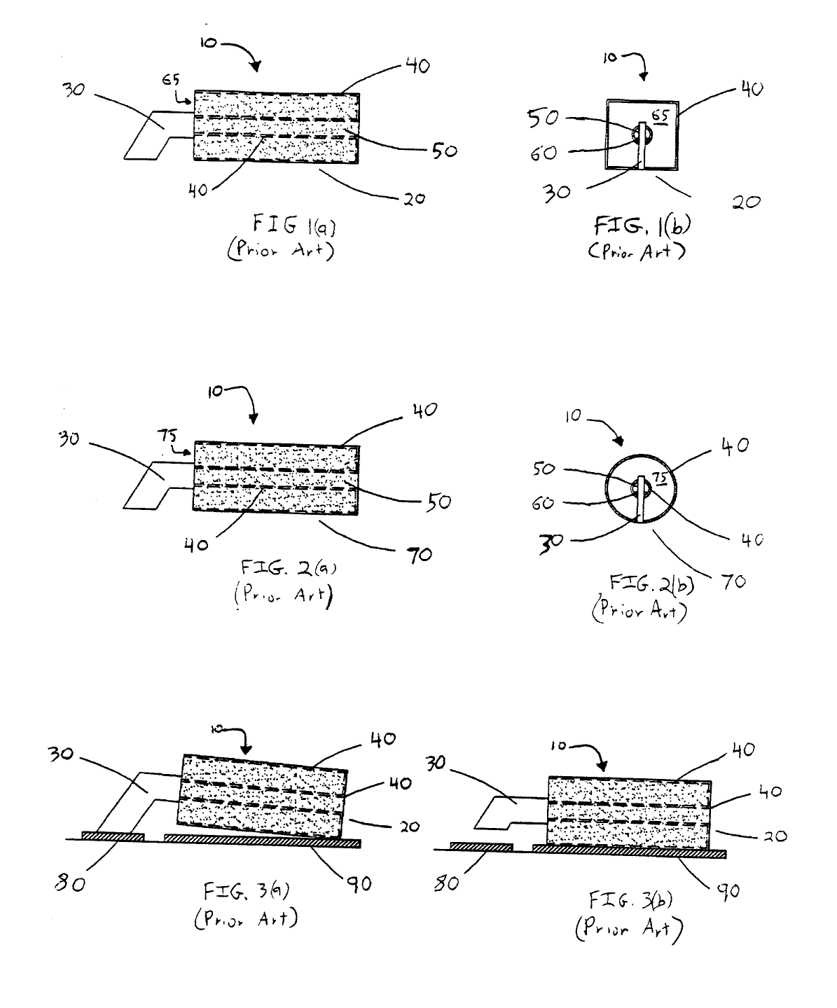

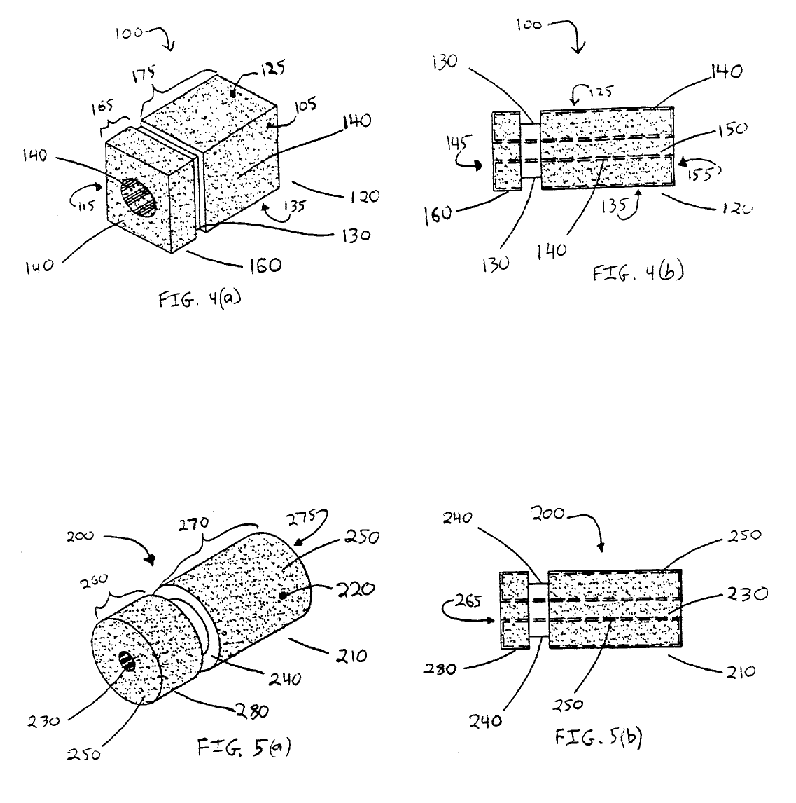

### DETAILED DESCRIPTION OF THE PREFERRED EMBODIMENTS

Before starting a description of the Figures, instructions for interpreting the words and phrases of this patent document will be provided. More particularly, many jurisdictions allow a patentee to act as its own lexicographer, and thereby allow the patentee to provide instructions in a patent document as to how the words, terms and phrases of the document are to be interpreted as a legal matter. For example, in the United States, the prerogative of the patentee to act as its own lexicographer has been solidly established based on statutory and case law. Accordingly, the following section provides rules for interpreting the words, terms and phrases of this particular patent document.

Interpretive Rules

Rule 1: There is a “Specially Defined Terms” section set forth below. Only words, terms or phrases that are explicitly defined in the Specially Defined Terms are to be considered to have a special definition, and, of course, the explicit definition provided herein is to serve as the definition for these terms. Accordingly, sources such as the patent specification and extrinsic evidence shall not be used to help define these terms—the explicitly provided definitions shall control.

Rule 2: If a word, term or phrase is not specially defined, then its definition shall be determined in the first instance by resort to dictionaries and technical lexicons that either exist as of the time this patent document is filed. (See definition of “dictionaries and technical lexicons” below in the Specially defined Terms section.) It is acknowledged that dictionaries and technical lexicons often provide alternative definitions. Also, definitions provided in different dictionaries and different lexicons often differ and are not always entirely consistent. In that case, it must be decided which definition is in best accordance with this document. Rules 3 and 4, set forth below, provide some guidelines for choosing between alternative definitions for a word, term or phrase.

Rule 3: The role of the specification (other than the Specially Defined Terms section) as an interpretive or definitional aid shall be limited to helping choose between alternative definitions that meet the requirements of Rule 2 (above).

Rule 4: The role of extrinsic evidence (e.g., expert witnesses) as an interpretive or definitional aid shall be limited to helping choose between alternative definitions that meet the requirements of Rule 2 (above).

Specially Defined Terms

the present invention: means at least some embodiments of the present invention; references to various feature(s) of the “present invention” throughout this document do not mean that all claimed embodiments or methods include the referenced feature(s).

dictionaries and/or technical lexicons: any document whose primary purpose is the definition of words, terms and/or phrases; on the other hand, documents that merely discuss, explain or provide examples of devices or methods, without purporting to provide definitions of specific words, phrases or terms, are not to be considered as dictionaries and/or technical lexicons.

To the extent that a patentee may act as its own lexicographer under applicable law, it is hereby further directed that all words appearing in the claims section, except for the above-defined words, shall take on their ordinary, plain and accustomed meanings (as generally evidenced, inter alia, by dictionaries and/or technical lexicons), and shall not be considered to be specially defined in this specification. Notwithstanding this limitation on the inference of “special definitions,” the specification may be used to evidence the appropriate ordinary, plain and accustomed meanings (as generally evidenced, inter alia, by dictionaries and/or technical lexicons), in the situation where a word or term used in the claims has more than one alternative ordinary, plain and accustomed meaning and the specification is helpful in choosing between the alternatives.

Referring to FIGS. 4(a) and 4(b), a surface mount coaxial ceramic resonator 100 according to a first embodiment of the present invention, includes a square resonator body 120 having a through hole 150 and a groove 130 surrounding its circumference. A conductive coating 140 envelops the outer diameter of the through hole 150 as well as the entire perimeter of the square resonator body 120, except for within groove 130. In total, the square resonator body 120 has six facets including a front side 105, back side 115, top side 125, bottom side 135, short end 145 and long end 155. The groove 130 divides the resonator body 120 into a short section 165 including short end 145 and a long section 175 including long end 155. By cutting the groove 130 around the perimeter of the resonator body 120, the conductive coating 140 is removed, which allows the short section 165 to act as a surface mount pad 160 that is in electrical connection with the through hole 150.

Referring to FIG. 8(a), the resonator body 120 with groove 130 is attached to circuit board 180, 190 by soldering such that an electrical connection is made between the surface mount pad 160 and a metal connecting pad 180 on circuit board 180,190. As one of ordinary skill in the art would appreciate, the electrically isolated short section 165 replaces the metal tab 30 by creating a proper electrical connection between the resonator 100 and circuit 180,190. Thus, the problematic metal tab 30 of conventional coaxial resonators is eliminated by the present invention and replaced by an inexpensive substitute.

Referring to FIGS. 5(a), 5(b) and 8(b), a surface mount coaxial ceramic resonator 200 according to a second embodiment of the present invention, includes a circular resonator body 210 having a rounded exterior wall 220 a through hole 230 and a groove 240 surrounding its circumference. Once more, a conductive coating 250 envelops the outer diameter of the through hole 230 as well as the entire perimeter of the resonator body 210, except within groove 240. Similar to the previous embodiment, the groove 240 divides the resonator body 210 into a short section 260 including short end 265 and a long section 270 including long end 275. By cutting the groove 240 around the perimeter of the resonator body 210, the conductive coating 250 is removed, which allows the short section 260 to act as a surface mount pad 280 that is in electrical connection with the through hole 230. The resonator body 210 can be attached to circuit board 180,190 by soldering such that an electrical connection is made between the surface mount pad 280 and metal connecting pad 180.

A method will now be described for making the grooved, coaxial, surface mount resonator bodies of the present invention. Each resonator body may be formed by pressing or extruding ceramic dielectric materials in the shape of an elongated square, rectangle, or cylinder body having a through hole, which runs the entire length of the resonator body. Of course, a resonator body may have numerous other shapes without departing from the scope of this invention. The length of a resonator body affects the frequency of the finished resonator, whereby a longer body will have a lower frequency and a shorter body will have a higher frequency.

After the resonator bodies are formed, the green, unfired bodies are then fired in high temperature kilns to form high K dielectric ceramic components. Then a conductive coating is applied to all inner and outer surfaces of the resonator body. Preferably, this coating includes silver, copper or other highly conductive substances. After coating, a groove is cut around the resonator body perimeter creating a non-conductive gap that electrically isolates the resonator into two parts.

The groove of the various embodiments of the present invention is a circular or square rut surrounding the perimeter of the resonator body in a single vertical plane (see FIGS. 4-9). However, as one of ordinary skill in the art would appreciate, it is not required that the groove be a located in a single vertical plane. In fact, the groove can be nearly any shape or size, so long as it achieves the desired electrical isolation. For instance, the groove may follow a wavy or zigzag path around the perimeter of the resonator body. The groove can be cut using a saw, grinder, laser or other suitable cutting device. The depth of the groove is not particularly important except that it is imperative that cutting device cuts all the way through the conductive layer.

Referring to FIGS. 6(a) and 6(b), a square surface mount coaxial ceramic resonator 300 according to a third embodiment of the present invention is similar to the first embodiment, and like elements have been numbered accordingly. According to the third embodiment, groove 330 is again a non-conductive gap 330 that creates a conductive surface mount pad 160 on short section 165 of the resonator body 120, and the surface mount pad 160 connects to the conductive coating 140 inside the through hole 150. However, the groove 330 is formed by a masking process, whereby a mask 350, such as a band of tape 350, is placed around the perimeter of the resonator body 120 before the conductive coating 140 is applied.

After coating, the mask 350 is removed and a non-conductive gap 330 or groove 330 is formed around the perimeter of the body 120 in the shape of the band. As one of ordinary skill in the art would understand, masking may be accomplished using a band of any number of other materials including, but not limited to paper, plastic, rubber and metal.

Referring to FIG. 8(b), the resonator body 120 with groove 330 is attached to circuit board 180, 190 by soldering such that an electrical connection is made between the surface mount pad 160 and a metal connecting pad 180 on circuit board 180,190. Again, the electrically isolated short section 165 functions as an inexpensive substitute for the conventional metal tab 30 of the prior art surface mount resonators by creating a proper electrical connection between the resonator 100 and circuit 180,190.

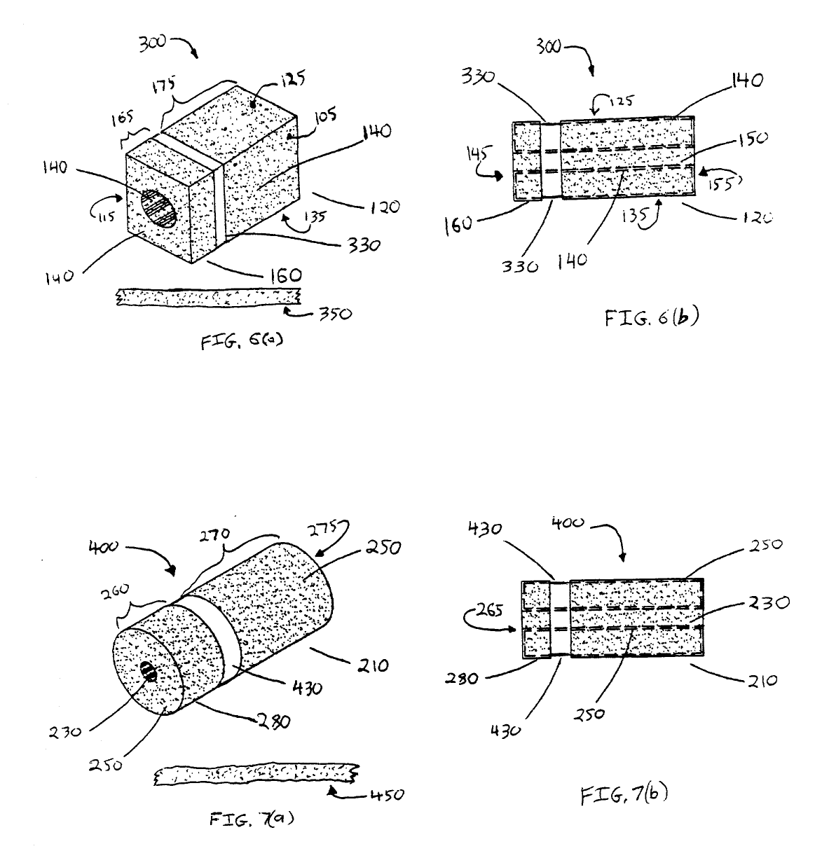

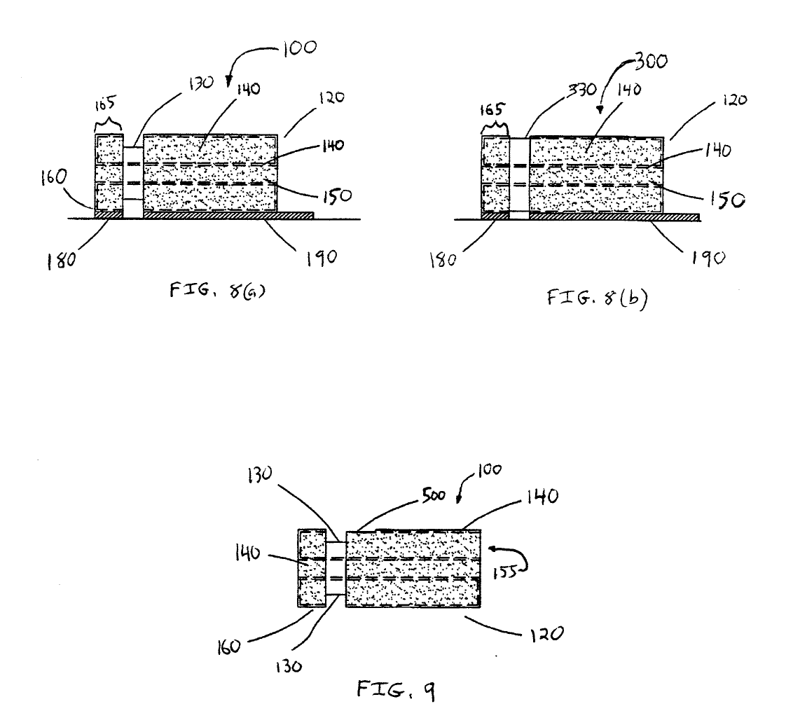

Referring to FIGS. 7(a) and 7(b), a circular surface mount coaxial ceramic resonator 400 according to a fourth embodiment of the present invention is similar to the second embodiment, and like elements have been numbered the same. According to the fourth embodiment, groove 430 is a non-conductive gap 430 formed by a masking process similar to the third embodiment, whereby a mask 450, such as a band of tape 450, is placed around the perimeter of the resonator body 210 before the conductive coating 250 is applied.

Referring to FIG. 9, after the above method of making resonator bodies has been utilized, a surface mount coaxial ceramic resonator 100 according to the present invention may be tested for frequency. The measured frequency can be increased by removing conductive coating 140 from an area on the resonator body 120 adjacent to the groove 130, such as area 500. Further, the measured frequency can be decreased by removing the conductive coating 140 from the long end 155 of the resonator body 120. The present invention contemplates both quarter wave coaxial resonators having both ends fully metallized (i.e., shorted), and half wave resonators wherein the conductive coating 140 on the long end 155 has been removed.

Many variations on the above-described invention are possible. Such variations are not to be regarded as a departure from the spirit and scope of the invention, but rather as subject matter intended to be encompassed within the scope of the following claims, to the fullest extent allowed by applicable law.

What is claimed is:

1. A resonator comprising:
a resonator body having a longitudinally extending through hole such that the body has inner and outer surfaces;
an electrically conductive coating formed on the inner and outer surfaces of the resonator; and
an electrical gap formed around the circumference of the body.

2. The resonator of claim 1, wherein the electrical gap is formed by an absence of conductive coating.

3. The resonator of claim 2, wherein the electrical gap is formed by cutting a groove around the circumference of the body to form a non-conductive band.

4. The resonator of claim 2, wherein the electrical gap is formed by grinding a groove around the circumference of the body to form a non-conductive band.

5. The resonator of claim 2, wherein the electrical gap is formed by laser scribing a groove around the circumference of the body to form a non-conductive band.

6. The resonator of claim 2, wherein the electrical gap is formed by masking an area around the circumference of the body before the conductive coating is applied and removing the mask after the conductive coating is applied, to form a non-conductive band.

7. The resonator of claim 1, wherein the electrical gap forms a conductive mounting pad adapted to be attached to a circuit board.

8. The resonator of claim 1, wherein the resonator has a square resonator body.

9. The resonator of claim 8, wherein the square resonator body has six facets including a front side, back side, top side, bottom side, short end and long end.

10. The resonator of claim 9, wherein the electrical gap is formed in four facets of the square resonator body.

11. The resonator of claim 10, wherein the electrical gap is a band formed around the front, back, top and bottom sides of the square resonator body.

12. The resonator of claim 11, wherein the through hole extends from the short end to the long end of the square resonator body.

13. The resonator of claim 11, wherein the band divides the resonator body into a short section and a long section.

14. The resonator of claim 13, wherein the short section is used as a conductive pad for attachment to a circuit board.

15. The resonator of claim 1, wherein the resonator has a circular resonator body.

16. The resonator of claim 15, wherein the circular resonator body is a cylinder having a short end and a long end.

17. The resonator of claim 16, wherein the electrical gap is a band formed around the cylinder.

18. The resonator of claim 17, wherein the through hole extends from the short end to the long end of the circular resonator body.

19. The resonator of claim 18, wherein the band divides the resonator body into a short section and a long section.

20. The resonator of claim 19, wherein the short section is used as a conductive pad for attachment to a circuit board.

21. The resonator of claim 1, wherein the conductive coating near the electrical gap is removed to increase the resonator frequency.

22. The resonator of claim 1, wherein the electrical gap divides the resonator body into a short section having a short end and a long section including a long end, wherein the conductive coating on the long end is removed to decrease the resonator frequency.

23. A method of making a resonator, comprising the steps of:
forming a resonator body;
forming a longitudinally extending through hole in the body such that the body has inner and outer surfaces;
coating the inner and outer surfaces with an electrically conductive coating; and
forming an electrical gap around the circumference of the body.

24. The resonator of claim 23, wherein the step of forming the electrical gap includes the step of cutting a groove around the circumference of the body to form a non-conductive band.

25. The resonator of claim 23, wherein the step of forming the electrical gap includes the step of grinding a groove around the circumference of the body to form a non-conductive band.

26. The resonator of claim 23, wherein the step of forming the electrical gap includes the step of laser scribing a groove around the circumference of the body to form a non-conductive band.

27. The resonator of claim 23, wherein the step of forming the electrical gap includes the step of masking an area around the circumference of the body before the conductive coating is applied.

28. The resonator of claim 27, wherein the step of forming the electrical gap further includes the step of removing the mask after the conductive coating is applied forming a nonconductive band.

29. The resonator of claim 23, wherein the step of forming the electrical gap includes the step of forming a conductive mounting pad for attachment to a circuit board.

30. The resonator of claim 23, wherein the step of forming a resonator body includes the step of forming a square resonator body.

31. The resonator of claim 30, wherein the step of forming a square resonator body includes the step of forming a square resonator body having six facets including a front side, back side, top side, bottom side, short end and long end.

32. The resonator of claim 31, wherein the step of forming a resonator body includes the step of forming the electrical gap in four facets of the square resonator body.

33. The resonator of claim 32, wherein the step of forming a resonator body includes the step of forming the electrical gap around the front, back, top and bottom sides of the square resonator body.

34. The resonator of claim 33, wherein the step of forming a resonator body includes the step of forming the through hole from the short end to the long end of the square resonator body.

35. The resonator of claim 33, wherein the step of forming the electrical gap includes the step of dividing the resonator body into a short section and a long section with a nonconductive band.

36. The resonator of claim 35, further comprising the step of using the short section as a conductive pad for attachment to a circuit board.

37. The resonator of claim 23, wherein the step of forming a resonator body includes the step of forming a circular resonator body.

38. The resonator of claim 37, wherein the step of forming a circular resonator body includes the step of forming a cylinder having a short end and a long end.

39. The resonator of claim 38, wherein the step of forming an electrical gap includes the step of forming a non-conductive band around the cylinder.

40. The resonator of claim 39, wherein the step of forming the through hole includes the step of forming the through hole from the short end to the long end of the circular resonator body.

41. The resonator of claim 40, wherein the step of forming the non-conductive band includes the step of dividing the resonator body into a short section and a long section.

42. The resonator of claim 41, further including the step of using the short section as a conductive pad for attachment to a circuit board.

43. The resonator of claim 23, further including the step of removing the conductive coating near the electrical gap to increase the resonator frequency.

44. The resonator of claim 23, wherein the step of forming an electrical gap includes the step of dividing the resonator body into a short section having a short end and a long section having a long end.

45. The method of claim 44, further including the step of removing the conductive coating on the long end to decrease the resonator frequency.
